(19) United States
(12) Patent Application Publication
(10) Pub. No.: US 2015/0168574 A1
(43) Pub. Date: Jun. 18, 2015

(54) SEISMIC TRACE ATTRIBUTE

(71) Applicant: Schlumberger Technology Corporation, Sugar Land, TX (US)

(72) Inventors: Bradley Clark Wallet, Stavanger (NO); Victor Aarre, Stavanger (NO)

(21) Appl. No.: 14/407,857

(22) PCT Filed: Jul. 16, 2013
(86) PCT No.: PCT/IB2013/001548

§ 371 Date: Dec. 12, 2014

Related U.S. Application Data
(60) Provisional application No. 61/659,036, filed on Jun. 13, 2012.

(51) Int. Cl. G01V 1/30; G01V 1/36; G01V 1/34

(52) U.S. Cl. CPC G01V 1/303; G01V 1/34; G01V 1/368; G01V 1/301

(57) ABSTRACT

A method can include providing seismic data for a subsurface region that includes a reflector; processing at least a portion of the seismic data to generate at least one path that extends orthogonally to the reflector; and outputting output data representing the at least one path. Various other apparatuses, systems, methods, etc., are also disclosed.

### RELATED APPLICATIONS

This application claims the benefit of U.S. Provisional Patent Application having Ser. No. 61/659,036, filed 13 Jun.2012, which is incorporated by reference herein.

### BACKGROUND

Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Various techniques described herein pertain to processing of data such as, for example, seismic data.

### SUMMARY

A method can include providing seismic data for a subsurface region that includes a reflector, processing at least a portion of the seismic data to generate at least one path that extends orthogonally to the reflector and outputting output data representing the at least one path. A system can include one or more processors for processing information, memory operatively coupled to the one or more processors, and modules that include instructions stored in the memory and executable by at least one of the one or more processors, where the modules include a provision module to provide seismic data for a subsurface region that includes a reflector, a process module to process at least a portion of the seismic data to generate at least one path that extends orthogonally to the reflector, and an output module to output data representing the at least one path. One or more computer-readable storage media can include computer-executable instructions to instruct a computing system to access seismic data for a subsurface region that includes a reflector, process at least a portion of the seismic data to generate at least one path that extends orthogonally to the reflector, and output data representing the at least one path. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment;

FIG. 2 illustrates examples of formations, an example of a convention for dip, an example of data acquisition, and an example of a system;

FIG. 3 illustrates an example of a method for acquiring and processing data;

FIG. 4 illustrates an example of a method for processing data;

FIG. 5 illustrates an example of output data;

FIG. 6 illustrates examples of images of data;

FIG. 7 illustrates examples of images of data;

FIG. 8 illustrates examples of images of data;

FIG. 9 illustrates examples of methods; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

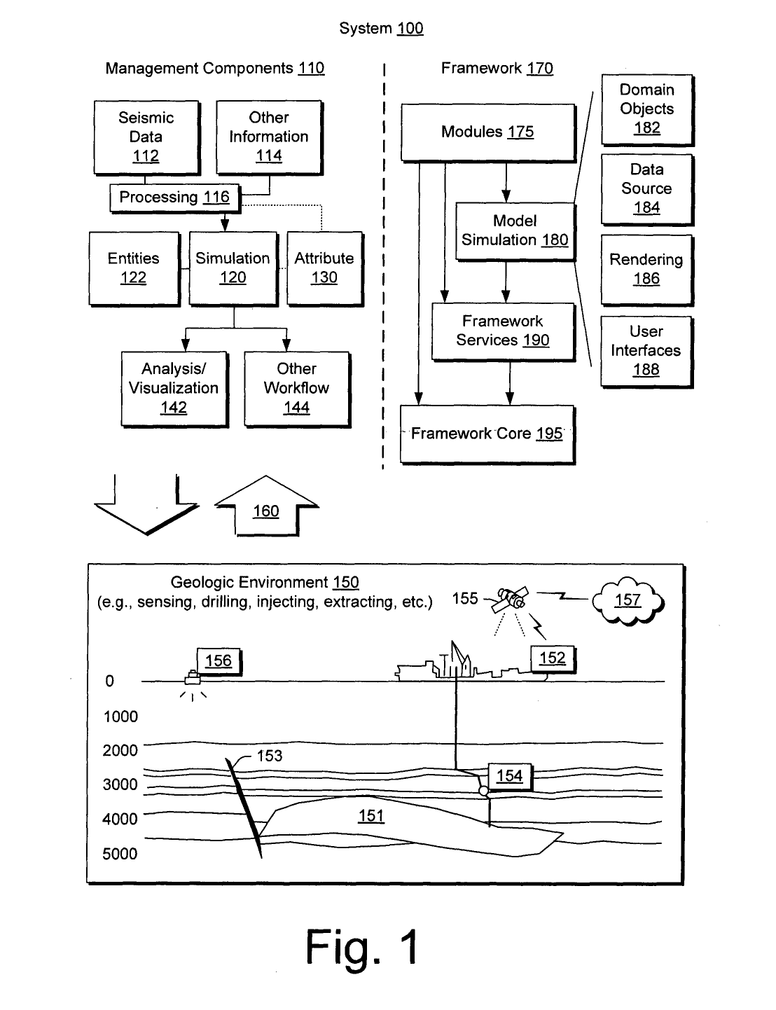

FIG. 1 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a reservoir or reservoirs may be simulated with respect to one or more enhanced recovery techniques (e.g., consider a thermal process such as SAGD, etc.).

In an example embodiment, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may be outfitted with any of a variety of sensors, detectors, actuators, etc. For example, equipment 152 may include communication circuitry to receive and to transmit information with respect to one or more networks 157. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 155 that may be configured for communications, noting that the satellite 155 may additionally or alternatively include circuitry for imagery (e.g., spatial, spectral, temporal, radiometric, etc.).

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

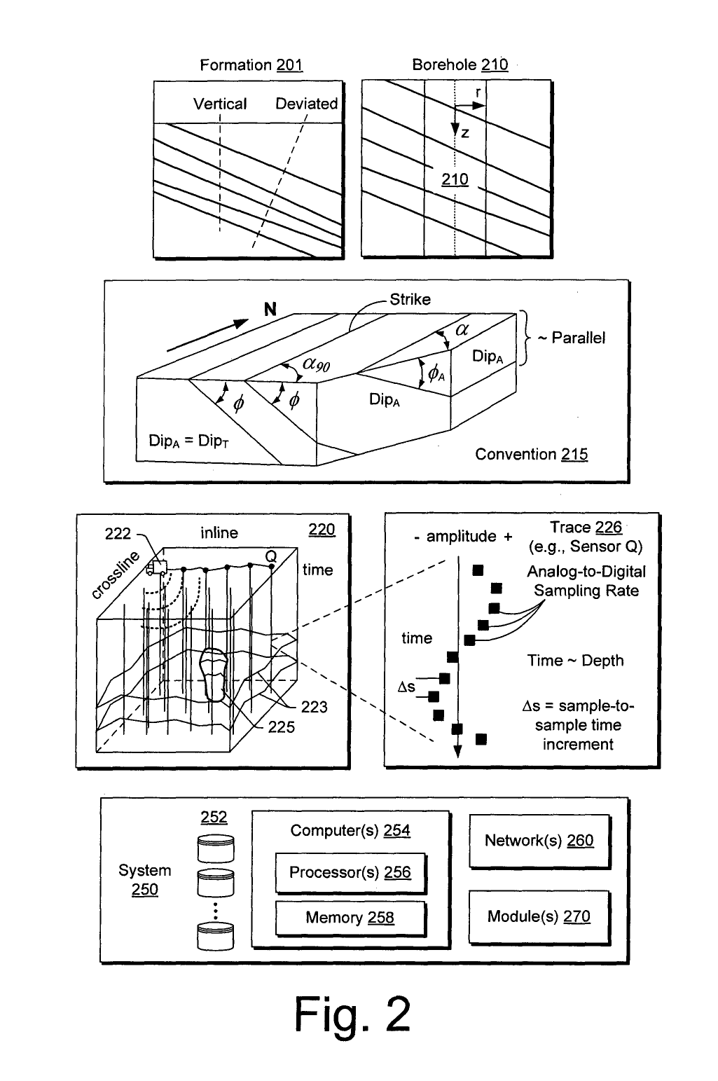

FIG. 2 shows an example of a formation 201, an example of a borehole 210, an example of a convention 215 for dip, an example of a data acquisition process 220, and an example of a system 250.

As shown, the formation 201 includes a horizontal surface and various subsurface layers. As an example, a borehole may be vertical. As another example, a borehole may be deviated. In the example of FIG. 2, the borehole 210 may be considered a vertical borehole, for example, where the z-axis extends downwardly normal to the horizontal surface of the formation 201.

As to the convention 215 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 215 of FIG. 2, various angles φ indicate angle of slope downwards, for example, from an imaginary horizontal plane (e.g., flat upper surface); whereas, azimuth refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 215 of FIG. 2). True dip is the dip of a plane measured directly perpendicular to strike (see, e.g., line directed northwardly and labeled “strike” and angle φ₉₀) and also the maximum possible value of dip magnitude. Another term is “apparent dip” (see, e.g., Dip_{A} in the convention 215 of FIG. 2). Apparent dip may be the dip of a plane as measured in any other direction except in the direction of true dip (see, e.g., 100 _{A} as Dip_{A} for angle φ); however, it is possible that the apparent dip is equal to the true dip (see, e.g., φ as Dip_{A}=Dip_{T} for angle φ₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 215 of FIG. 2, the dip of a plane as seen in a cross-section exactly perpendicular to the strike is true dip (see, e.g., the surface with 100 as Dip_{A}=Dip_{T} for angle φ₉₀ with respect to the strike). As indicated, dip observed in a cross-section in any other direction is apparent dip (see, e.g., surfaces labeled Dip_{A}). Further, as shown in the convention 215 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. The resulting dips from such a process are called relative dips and find use in interpreting sand body orientation.

A convention such as the convention 215 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.).

Seismic interpretation may aim to identify and classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As shown in the diagram 220 of FIG. 2, a geobody 225 may be present in a geologic environment. For example, the geobody 225 may be a salt dome. A salt dome may be a mushroom-shaped or plug-shaped diapir made of salt and may have an overlying cap rock. Salt domes can form as a consequence of the relative buoyancy of salt when buried beneath other types of sediment. Hydrocarbons may be found at or near a salt dome due to formation of traps due to salt movement in association with evaporite mineral sealing. Buoyancy differentials can cause salt to begin to flow vertically (e.g., as a salt pillow), which may cause faulting. In the diagram 220, the geobody 225 is met by layers which may each be defined by a dip angle φ.

As an example, seismic data may be acquired for a region in the form of traces. In the example of FIG. 2, the diagram 220 shows acquisition equipment 222 emitting energy from a source (e.g., a transmitter) and receiving reflected energy via one or more sensors (e.g., receivers) strung along an inline direction. As the region includes layers 223 and the geobody 225, energy emitted by a transmitter of the acquisition equipment 222 can reflect off the layers 223 and the geobody 225. Evidence of such reflections may be found in the acquired traces. As to the portion of a trace 226, energy received may be discretized by an analog-to-digital converter that operates at a sampling rate. For example, the acquisition equipment 222 may convert energy signals sensed by sensor Q to digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter-acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

In the example of FIG. 2, the system 250 includes one or more information storage devices 252, one or more computers 254, one or more networks 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc.

In the example of FIG. 2, the one or more memory storage devices 252 may store seismic data for a geologic environment that spans kilometers in length and width and, for example, around 10 km in depth. Seismic data may be acquired with reference to a surface grid (e.g., defined with respect to inline and crossline directions). For example, given grid blocks of about 40 meters by about 40 meters, a 40 km by 40 km field may include about one million traces. Such traces may be considered 3D seismic data where time approximates depth. As an example, a computer may include a network interface for accessing seismic data stored in one or more of the storage devices 252 via a network. In turn, the computer may process the accessed seismic data via instructions, which may be in the form of one or more modules.

As an example, one or more attribute modules may be provided for processing seismic data. As an example, attributes may include geometrical attributes (e.g., dip angle, azimuth, continuity, seismic trace, etc.). Such attributes may be part of a structural attributes library (see, e.g., the attribute component 130 of FIG. 1). Structural attributes may assist with edge detection, local orientation and dip of seismic reflectors, continuity of seismic events (e.g., parallel to estimated bedding orientation), etc. As an example, an edge may be defined as a discontinuity in horizontal amplitude continuity within seismic data and correspond to a fault, a fracture, etc. Geometrical attributes may be spatial attributes and rely on multiple traces.

As mentioned, as an example, seismic data for a region may include one million traces where each trace includes one thousand samples for a total of one billion samples. Resources involved in processing such seismic data in a timely manner may be relatively considerable by today's standards. As an example, a dip scan approach may be applied to seismic data, which involves processing seismic data with respect to discrete planes (e.g., a volume bounded by discrete planes). Depending on the size of the seismic data, such an approach may involve considerable resources for timely processing. Such an approach may look at local coherence between traces and their amplitudes, and therefore may be classified in the category of “apparent dip.”

As an example, a 2D search-based estimate of coherence may be performed for a range of discrete dip angles. Such an approach may estimate coherence using semblance, variance, principle component analysis (PCA), or another statistical measure along a discrete number of candidate dips and arrive at an instantaneous dip based on a coherence peak. As an example, a 3D search-based estimate of coherence, which may be analogous to a 2D approach, may use an inline vector and a crossline vector for time dip (e.g., along coherent peaks in inline and crossline directions). As an example, dip with maximum coherence may be stored as a dip angle/magnitude and dip direction/azimuth. As an example, an approach may involve human interaction in a semi-automated manner that includes interpretation of horizons in a subterranean formation via user identification and selection of horizon features.

As an example, an attribute may be a trace attribute. For example, a trace attribute process that generates an iso-frequency attribute may include performing spectral decomposition on seismic data to generate an autocorrelation function followed by cross-correlation using a cosine wave (e.g., cosine correlation transform) and the autocorrelation function. Such a process can output an iso-frequency attribute as a correlation coefficient that measures the correlation between a known cosine wave signature of a particular frequency and the autocorrelation of the seismic data. Such a trace attribute process may be applied to a seismic volume and, for example, output an iso-frequency attribute cube (e.g., with values scaled between −1 and +1, representing correlation). An iso-frequency attribute may help reveal variations in lithology that may, for example, indicate stratigraphic traps for hydrocarbons.

As an example, a trace attribute may be a one-dimensional attribute, referred to as a 1D trace attribute, where calculations may benefit from input of values that are properly spaced along a trace (e.g., or traces). Improper spacing of values along a trace may arise under various circumstances, for example, related to orientation of seismic data acquisition equipment with respect to one or more reflectors (e.g., dipping planes, geobodies, etc.), processing of seismic data, etc. As an example, properly spaced values for a trace may be defined by their distances, times, etc. For example, properly spaced values may be amplitude values for samples where individual amplitude values have corresponding times or distances that may help to preserve one or more characteristics of a wavelet or wavelets. As an example, consider amplitude values having corresponding times that help to preserve frequency of a wavelet.

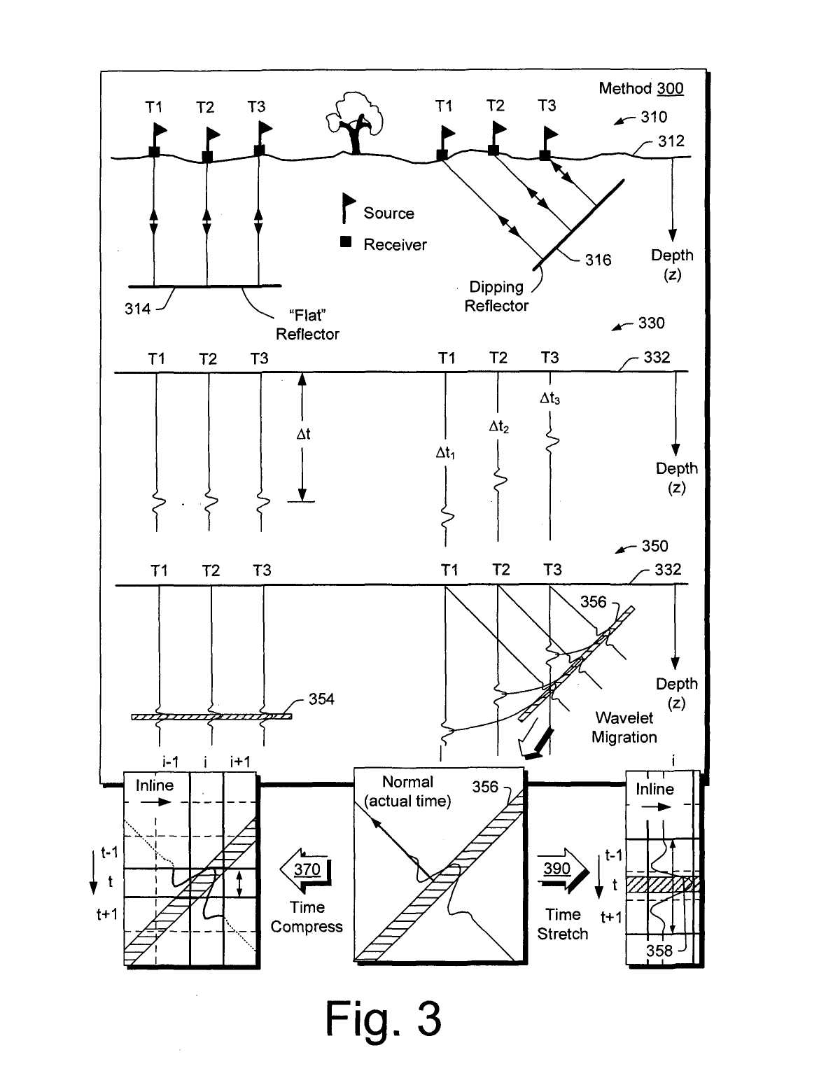

FIG. 3 shows an example of a method 300 that demonstrates how improper spacing, etc., may occur for seismic data (e.g., trace data). In the method 300, for a data acquisition process 310, various source and receiver pairs are positioned on a surface 312, below which exists a flat reflector 314 and a dipping reflector 316. For each source and receiver pair, a two-way-travel-time (TWT) is represented as a double headed arrow (e.g., energy wave travel time from the source to the respective reflector and from the respective reflector to the receiver).

In the method 300, for a data process 330, each of the traces for the flat reflector 314 and each of the traces for the dipping reflector 316 are shown as including a wavelet having an associated time (e.g., Δt for the flat reflector 314 and Δt₁, Δt₂ and Δt₃ for the dipping reflector 316). As an example, a wavelet may be defined as a one-dimensional pulse (e.g., a response from a single reflector). As an example, a wavelet may be characterized by amplitude, frequency and phase, for example, where energy that returns cannot exceed what was input, so that the energy in any received wavelet decays with time as more partitioning takes place at interfaces. As an example, a wavelet may also decay due to loss of energy as heat during propagation, for example, higher frequency may result in more heat losses. As a consequence, a wavelet may tend to include less high-frequency energy relative to low frequencies at longer travel-times. As an example, a wavelet may be defined, for example, by shape, spectral content (e.g., Ricker wavelet), etc.

Referring to the trace 226 of FIG. 2, a wavelet may have positive and negative amplitudes with respect to time (e.g., or depth). As an example, seismic data may be organized with respect to inline, crossline and time or depth dimensions. As an example, seismic data may be organized as voxels where each sample (e.g., amplitude) is deemed representative of a volume of a subsurface environment, for example, which may be defined by inline, crossline and time or depth indexes or dimensions. In the example trace 226 of FIG. 2, the amplitude of each sample may optionally be stored with respect to a common inline index, a common crossline index and a series of time or depth indexes. In such an example, amplitude and time (or depth) may be preserved (e.g., proper where meaningful acquisition times are provided for amplitude values).

In the method 300, a wavelet migration process 350 may be applied to migrate the wavelets of the traces associated with the dipping reflector 316. As shown in the example of FIG. 3, each of the wavelets is migrated along a curve (e.g., radius of a circle) to align each of the wavelets with the dipping reflector 316. In such an example, the migration process 350 may result in wavelets being oriented normal to a plane defined by the dipping reflector 316. However, application of a discretization process 370 (e.g., pixilation, voxelation, etc.) or flattening process 390 can result in a migrated wavelet being “smeared” across a dimension or dimensions. For example, as shown, the process 370 may produce a migrated wavelet that is smeared across several inline columns (e.g., consider inline column indexes i−1, i+1, etc.). Further, with respect to time (e.g., or depth), the migrated wavelet may be “compressed” (e.g., organized with respect to fewer times, depths, etc.). Yet further, the inline columns may be dimensionally larger than depths. For example, consider a depth-to-depth spacing of about 10 m and a column-to-column spacing of about 25 m. In such an example, a wavelet may be distorted by the discretization process 370. A distorted representation of values (e.g., amplitude values) that represent a wavelet may impact calculations such as, for example, frequency calculations.

As to the flattening process 390, in the example of FIG. 3, it aligns the wavelet normal to a flattened plane 358 along a single column (see, e.g., the inline column with index “i”). In such an example, the time window (e.g., time span) of the wavelet may be stretched. A distorted representation of values (e.g., amplitude values) that represent a wavelet may impact calculations such as, for example, frequency calculations.

In FIG. 3, the discretization process 370 and the flattening process 390 are shown with respect to discrete block dimensions larger than what may be implemented for a sampling process, discretization process, or flattening process, for example, consider the trace 226 of FIG. 2 where discretization “captures” positive and negative amplitudes over a range of time or depth indexes (or times or depths) sufficient to preserve a waveform or waveforms. Data acquisition, sampling, etc., may consider factors such as Nyquist frequency, etc., for example, to account for one or more frequencies, cycles per unit length, etc.

As an example, where a spectral decomposition process is applied to a single trace discretized as a single column in a seismic data volume (e.g., a seismic data cube), which may be smeared due to wavelet migration, the process might not generate particularly useful results because a portion of the wavelet exists in another column such as an adjacent column (e.g., which may be at the same time or depth), because a dimension has been stretched or because a combination of factors distort the wavelet. Accordingly, time (e.g., or depth) and amplitude may be improperly organized for the migrated wavelet (e.g., as stored in the seismic data volume).

As shown in the example of FIG. 3, various inaccuracies may arise for a region of structural deformation where traces are extracted vertically despite the fact that stratigraphic layers are oriented in a slanted or possibly curved manner. As an example, where a trace attribute process is applied, extraction of a trace (e.g., trace data such as amplitude) may be inaccurate for a structurally deformed region and hence lead to an inaccurate result (e.g., potentially of little relevance to interpretation, etc.). To generate a more accurate representation, as an example, a trace may be extracted orthogonal to one or more stratigraphic layers and optionally orthogonal to individual stratigraphic layers of a plurality of stratigraphic layers (e.g., reflectors). Such an approach may avoid “compression”, “stretching”, etc., of trace data and help to ensure that trace data are represented by an appropriate amount of “geological time” and, for example, presuming deformation happened after deposition, that the trace data are represented by a same or similar amount of vertical sedimentation.

As an example, a process may be applied that avoids a trace from being inappropriately “stretched”, which may result in a spectral profile that is shifted towards the lower frequencies. While FIG. 3 shows a flattening process 390, stretching may occur where trace data are organized along a vertical column that includes two or more dipping layers (e.g., the time or distance between dipping layers along that vertical column is greater than the time or distance between the dipping layers substantially along a direction normal to their surfaces).

As mentioned, a flattening process such as the process 390 may be applied to seismic data in an effort to account for structural deformation, for example, where flattening of a seismic volume aims to correct for deformation. Such a flattening process may be part of a pre-processing procedure that is followed by a calculation procedure that calculates one or more attributes by extracting data from the flattened seismic volume (e.g., with presumably corrected traces). However, as mentioned, such an approach can tend to make various trace-based attribute calculations problematic. For example, when the goal is to achieve a volume that is orthogonal in the three cardinal directions, stretching may occur along one or more of the directions to produce a data set suitable for visualization rather than a data set suitable for calculation of various attributes. For example, consider frequency attributes where such stretching may shift spectral content of extracted traces towards lower frequencies.

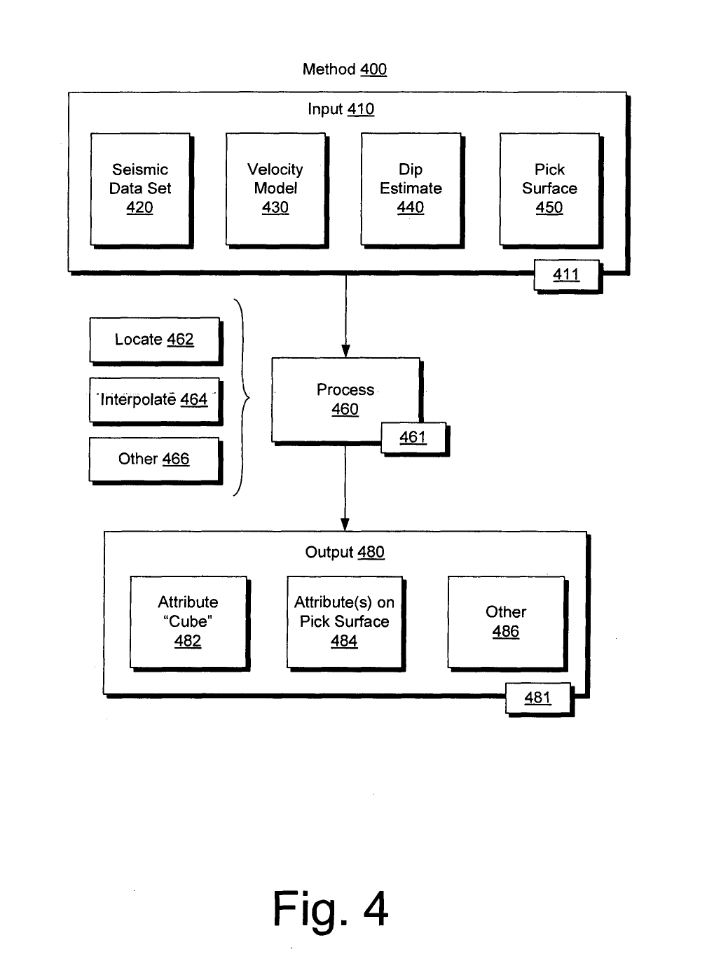

FIG. 4 shows an example of a method 400 that includes an input block 410, a process block 460 and an output block 480 where the process block 460 can process seismic data, for example, to output one or more seismic trace attributes. As an example, seismic data may include pre-processed seismic data, for example, seismic data that has been processed optionally as an attribute.

As an example, the process block 460 may support generation of linear, curved or linear and curved normal incidence rays, for example, normal to one or more reflectors (e.g., structures). As an example, the process block 460 may correct for situations where an increment along a dipping normal vector is longer than a unit distance (e.g., to avoid frequency distortion). As an example, the process block 460 may process data in a manner that aims to avoid distortions that may impact one or more frequency-sensitive attributes. For example, the process block 460 may process data in a manner that honor physical distance (e.g., meters, feet, travel-time, etc.) between samples along a surface normal incidence ray.

As an example, the process block 460 may extract traces by tracking curved normal-incidence rays that run piecewise orthogonal to (e.g., possibly pre-calculated) estimates of stratigraphic orientation (e.g., structural dip). Such traces may preserve proper spatial/temporal spacing of observations (e.g., data samples). As an example, such traces may be suitable for calculation of trace-based attributes, for example, optionally without honoring dimensions that may be implemented for visualization (e.g., for purposes of geometric interpretation, etc.).

As an example, the process block 460 may account for a seismic wavelet being found along a normal of stratigraphic layering in a subsurface environment. As an example, consider the “layer-cake” assumption where the Earth's interior is composed of a stack of flat layers and that a surface normal vector is parallel to the vertical axis. Given such an assumption, 1D volume attributes may be calculated in a vertical manner. However, the process block 460 may forego the “layer-cake” assumption, for example, to address one or more structural deformations. As an example, consider a workflow that aims to assess bounds, presence, etc., of one or more hydrocarbon reservoirs in a relatively complex geological setting such as one proximate to or including one or more salt bodies, in an area with substantial folding of layers, etc., where the “layer-cake” assumption may not apply. According to the process block 460, for such scenarios, a propagating wavelet (e.g., seismic reflectivity of a layer) may still be found along a normal of a surface in a time (depth)-migrated seismic volume.

To facilitate explanation of the method 400 of FIG. 4, one may refer again to the method 300 of FIG. 3, where one may assume, as an example, that the velocity of the seismic energy in the subsurface is approximately 0.5 m/s, and substantially constant, which can allow for interchangeability of TWT and distance (e.g., time dimension and depth dimension).

The process 310 of FIG. 3 is shown with respect to an example of a hypothetical seismic experiment with sets of seismic sources and receivers, where the sources and receivers are co-located (e.g., a zero-offset experiment). As mentioned, the subsurface includes a flat reflector 314 (left) and a constantly dipping reflector 316 (right). The process 330 of FIG. 3 is shown with respect to corresponding recorded traces, for example, where the left section is flat, just as for the corresponding geological layer represented by the flat reflector 314 while, the seismic section to the right is dipping (e.g., with a constant dip); however, the dip is not the same as the sampled geology as represented by the dipping reflector 316.

To reconstruct the true geological dip, the method 300 of FIG. 3 includes applying a seismic processing technique 350 referred to as migration. The output of the process 350, for the simplistic scenario of FIG. 3, includes speculative smear (e.g., “migration”) of each of the recorded samples to possible positions in the subsurface from which the reflection may have come from. For an assumed constant velocity, the process 350 may include rotating recorded samples along a circle path spatially. By performing such rotation for the three traces (e.g., and associated samples), the true geology may be re-constructed through constructive interference, and non-causal speculative samples may be cancelled out through destructive interference. In such an approach, at the edges of the dipping line, some remaining “migration smile” artifacts may exist, for example, due to insufficient lateral sampling at the edges of the image. Thus, for the method 300 of FIG. 3, for dipping layers, post migration, the reflected signal from the dipping layer may be embedded along the surface normal. In the example of FIG. 3, the process 350 results in the wavelets being tilted (e.g., tilted from vertical by rotation of the recorded signal).

Referring to the method 400 of FIG. 4, as an example, the process 460 can include extracting traces in such a manner that they are both orthogonal to stratigraphy, and that distances between measurement points (e.g., samples) are accurately preserved. As an example, one or more attributes may be calculated using such extracted traces or, for example, one or more attributes may be calculated during such an extracting process.

As an example, the process block 460 may include implementing a locating procedure per a locate block 462, implementing an interpolation procedure per an interpolation block 464, and/or implementing one or more other procedures per an “other” block 466. As an example, the process block 460 may include applying one or more techniques for trace extraction, for example, the process block 460 may include locating values per the locating block 462 and applying interpolation per the interpolation block 464 to a regular spacing of located values, interpolation to an irregular spacing of located values, a nearest neighbor approach for located values, etc.

In the example of FIG. 4, the input block 410 includes a seismic data set block 420, a velocity model block 430, a dip estimation block 440 and surface pick block 450; while the output block 480 includes an attribute cube block 482, an attribute(s) on pick surface block 484 and an “other” block 486, which may include one or more other types of output.

As to the seismic data set block 420, it may include providing seismic data organized with respect to various dimensions, for example, in 1D, 2D or 3D. As an example, data may be organized with respect to at least one index dimension, at least one distance dimension, at least one time dimension, or combinations thereof. For example, data may be organized with respect to an inline distance dimension and a time dimension. As an example, a time dimension (or times) may be converted to a distance dimension, for example, via use of a velocity model. In the example of FIG. 4, the velocity model block 430 may be provided for purposes of such a conversion or an inverse conversion, for example, from a time dimension to a distance dimension. For example, a vertical domain may be transformed from a time domain into a depth domain and, for example, a horizontal domain may be transformed from a distance domain into a time domain. Thus, the velocity model block 430 may provide one or more velocity models for purposes of transforming dimensions used to organize data (e.g., samples, etc.).

Where seismic data are organized with respect to a depth domain (e.g., distance dimension for depth), the method 400 may proceed without a velocity model. As an example, where seismic data are provided in a time domain (e.g., time dimension), the velocity model block 430 may provide a velocity model for transforming seismic data, for example, such that horizontal and vertical units may be the same (e.g., or readily converted). As an example, a velocity model may provide for estimating a velocity function for individual cells in a seismic data volume. As an example, a velocity function may be provided as an interval velocity field.

As to the dip estimation block 440, one or more estimation techniques may be provided as input, for example, for estimating orientation of one or more stratigraphic layers for the purposes of estimating traces. As an example, a dip field estimation process may be provided for estimating one or more dip parameters for a subsurface structure (e.g., reflector). As an example, a geo-mechanical process may be provided, for example, via igeoss® software (Schlumberger Limited, Houston, Tex.), via interfaces implemented for a seismic restoration project, etc. As an example, two or more interpreted horizons may be provided as part of a dip estimation process, for example, for use with layering between the horizons being estimated via a Laplace transform.

As an example, the process block 460 may optionally be configured to implement a process that includes calculating a root-mean square (RMS) value, for example, with operator radius “r” and for samples in a 3D seismic volume “V” organized with respect to indexes i, j and k. In such an example, the output block 480 may output results from the process 460 as an attribute volume “Vₐ” according to the attribute cube block 482.

As an example, approximate pseudo-code, without an algorithm that accounts for structural deformation (e.g, dipping), may calculate the attribute volume Vₐ as a matrix of values “result[i,k,j]” for a tracelet vector “tracelet[p]” as follows:

```
for every point (i,j,k) in⁻V
  int diameter = 1 + 2 * radius ;
  float array tracelet = new array ( diameter ) ;
  for ( p = 0 ; p < diameter ; p++)
    int kk = k − radius + p ;
    tracelet[p] = V[i,j,kk] ;
  endfor
  result[i,j,k] = CalculateRMS (tracelet) ;
endfor
```

As an example, approximate pseudo-code, with an algorithm that accounts for structural deformation (e.g, dipping), may calculate the attribute volume Vₐ as a matrix of values “result[i,k,j]” for a tracelet vector “tracelet[p]” as follows:

```
for every point (i,j,k) in V
  int diameter = 1 + 2 * radius ;
  float array tracelet = new array ( diameter ) ;
  for ( p = 0 ; p < diameter ; p++)
    float ii, jj, kk ;
    RayTraceToSamplePos ( inline Dip, Crossline Dip, Velocity model,
    i, j, k, p, radius, out ii, out jj, out kk ) ;
    tracelet[p] = Interpolate3D ( V, ii, jj, kk) ;
    endfor
  result[i,j,k] = CalculateRMS (tracelet) ;
endfor
```

In the foregoing example, the function “RayTraceToSamplePos” may include tracing the normal-incidence ray from a start-point (i,j,k) to a new end-point (ii,jj,kk) with a distance m==|diameter−p| samples away from the starting point (e.g., with two-way time equal to m*sr, where sr is the vertical sample rate for the seismic volume). In such an approach, the tracing may be considered a locating process (see, e.g., the locate block 462) where there may be two points with such a distance, for example, one above and one below the starting point; also the end-point may be somewhere in-between regularly sampled values in the 3D volume V, and hence a 3D interpolation may be performed to calculate the estimated value at that location (e.g., per the interpolation block 464).

As an example, a ray-tracing process may include accessing data (e.g., from voxel-to-voxel for 3D, a 2D slice, pixel-to-pixel, etc.), propagating along an updated surface normal for a current sample (e.g., voxel, pixel, etc.), and with an updated propagation velocity for each sample (e.g., voxel, pixel, etc.). As an example, a calculated end point for a ray-trace may end at a distance with a two-way travel-time set to be approximately equal to a multiple “m” of a vertical sample rate (e.g., measured in ms in a time dimension) for the seismic volume. For example, referring to the trace 226 of FIG. 2, a sample-to-sample time increment Δs is shown. As mentioned, a velocity model may provide for conversions between time (e.g., time dimension) and space (e.g., distance dimension).

As an example, where the process block 460 includes interpolation for 3D volume data, a 3D “sinc” interpolator may be implemented (e.g., as provided by the interpolation block 464, for example, where sinc(x)=sin(x)/x). However, where the input block 410 inputs data other than seismic data, such as, for example, a pre-calculated attribute volume (e.g., where structural dip estimates are pre-calculated and provided as inputs), the process block 460 may optionally apply another interpolation technique (e.g., bi-linear, quad-linear, polynomial, or other as part of the interpolation block 464).

As mentioned, the output block 480 may include the attribute cube block 482, the attribute(s) on pick surface block 484 and the other block 486. As an example, as to an output of the output block 480, the process 460 may derive information suitable for identifying particular values in a seismic data set (e.g., a seismic cube) for producing a trace (e.g., rendering a trace to a display). In such an example, spacing may be preserved for data, for example, for use in an attribute extraction process. As an example, given such information and its associated data, at a later time, a user may desire outputting information as an attribute cube for traces. As an example, consider a table of information that associates data with a trace (e.g., x, y, z locations in a seismic cube as being capable of defining a trace according to a fitted function, fitting function, etc., optionally specified with respect to a surface such as a reflector). In such an example, various traces may optionally be defined according to locations for data and, for example, optionally associated with one or more reflectors. Given such information, a method may include selecting a reflector, identifying one or more traces for that reflector and locations of data or, for example, locations sufficient to reconstruct a visual representation of one or more such traces. In turn, a user may select a location in a visual representation and examine or process data associated with a trace at that location (e.g., from a seismic cube, etc.). For example, such a method may include rendering a wavelet to a display (e.g., for analysis, interpretation, etc.).

The method 400 is shown in FIG. 4 in association with various computer-readable media (CRM) blocks 411, 421 and 431. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 400. As an example, a computer-readable medium (CRM) may be a computer-readable storage medium.

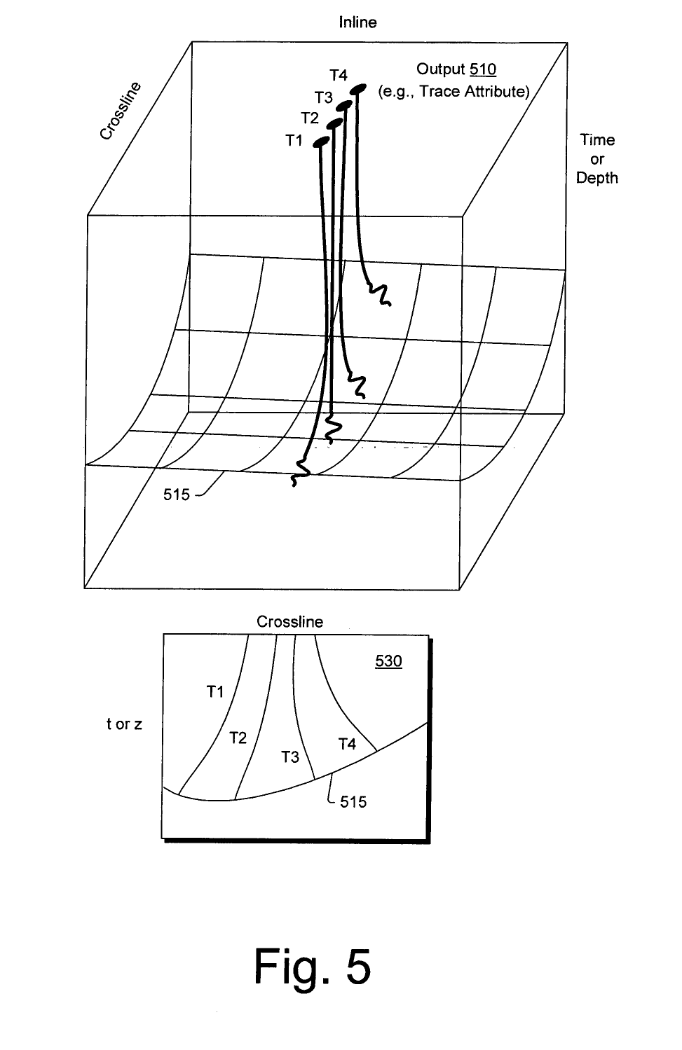

FIG. 5 shows an example of an output 510 as a volume with respect to three dimensions, for example, as output per the output block 480 of the method 400 of FIG. 4 (see, e.g., attribute cube block 482, etc.). As shown in FIG. 5, the output 510 includes four traces (T1, T2, T3 and T4) where each of the traces includes a respective wavelet associated with a reflector 515 (e.g., a subsurface structure). As an example, such traces may be referred to as “tracelets” or, for example, an individual trace may be referred to as a “tracelet”. As shown in FIG. 5, each of the four traces is approximately orthogonal to the reflector 515 at the reflector 515. For example, the reflector 515 may be defined as a surface using inline and crossline dimensions, which may be orthogonal to each other. In such an example, where a trace meets the reflector 515 at a point, the trace may be approximately orthogonal to an inline and may be approximately orthogonal to a crossline where the inline and the crossline pass through that point. For example, such a trace may be defined as being approximately normal to the reflector 515 (e.g., incident normally upon the reflector 515).

FIG. 5 also shows a 2D slice 530 of the output 510, for example, along a constant inline value (e.g., also consider a projection of the 3D output that collapses the inline dimension). In the 2D slice 530, the traces T1, T2, T3 and T4 are shown as being approximately orthogonal to the reflector 515 at the surface of the reflector (e.g., where the reflector 515 appears as a curved line). While the example of FIG. 5 shows the reflector 515 as a single reflector, multiple reflectors (e.g., layers) may be present along the depth of the volume, which give rise to the paths of the traces T1, T2, T3 and T4. As mentioned with respect to FIG. 4, rendered views such as those shown in FIG. 5 may optionally be reconstructed from information stemming from processing where the information may be specified with respect to data or data locations (e.g., for data in a seismic cube, an attribute cube, etc.).

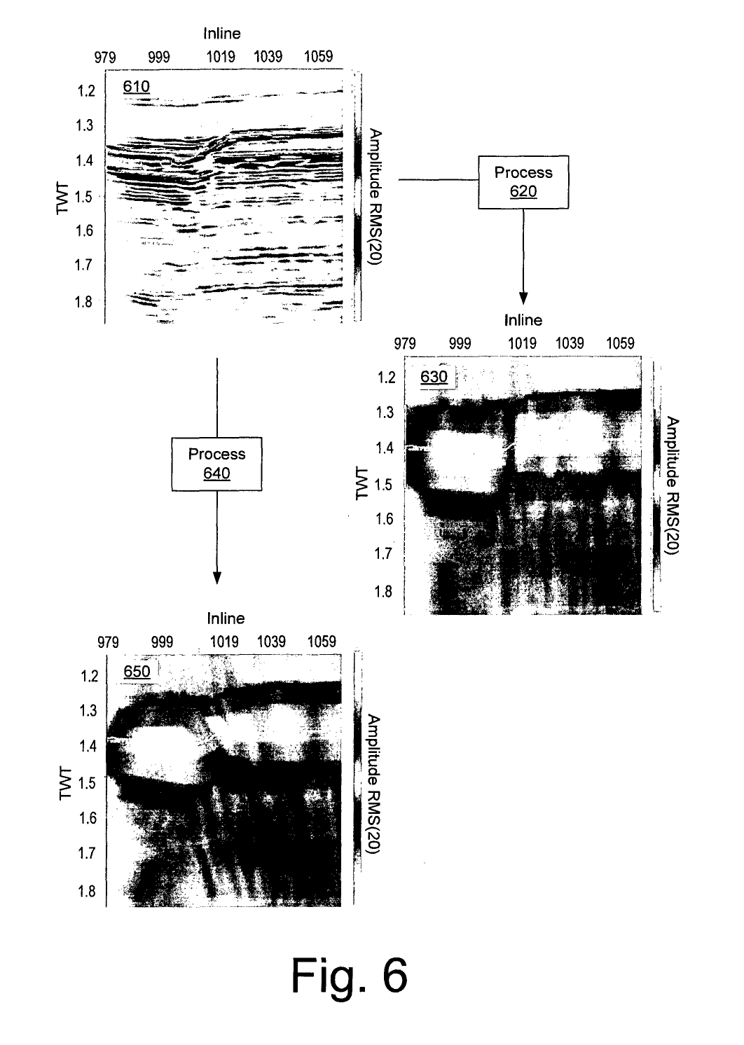

FIG. 6 shows images of data 610, 630 and 650 as being associated with two processes 620 and 640. The image of data 610 corresponds to an input seismic section (e.g., seismic data) organized with respect to an inline dimension and a time dimension for amplitude values given as RMS amplitude with an operator radius of b 20 samples, which is approximately a time dimension window length of about 164 ms.

The image of data 630 corresponds to output achieved by the process 620, which includes applying an RMS operator vertically to the seismic section (e.g., along inline columns); while the image of data 650 corresponds to output achieved by the process 640, which includes applying an RMS operator to samples from the seismic section extracted along a surface normal (e.g. an RMS operator operating on a curved or “non-vertical” tracelet).

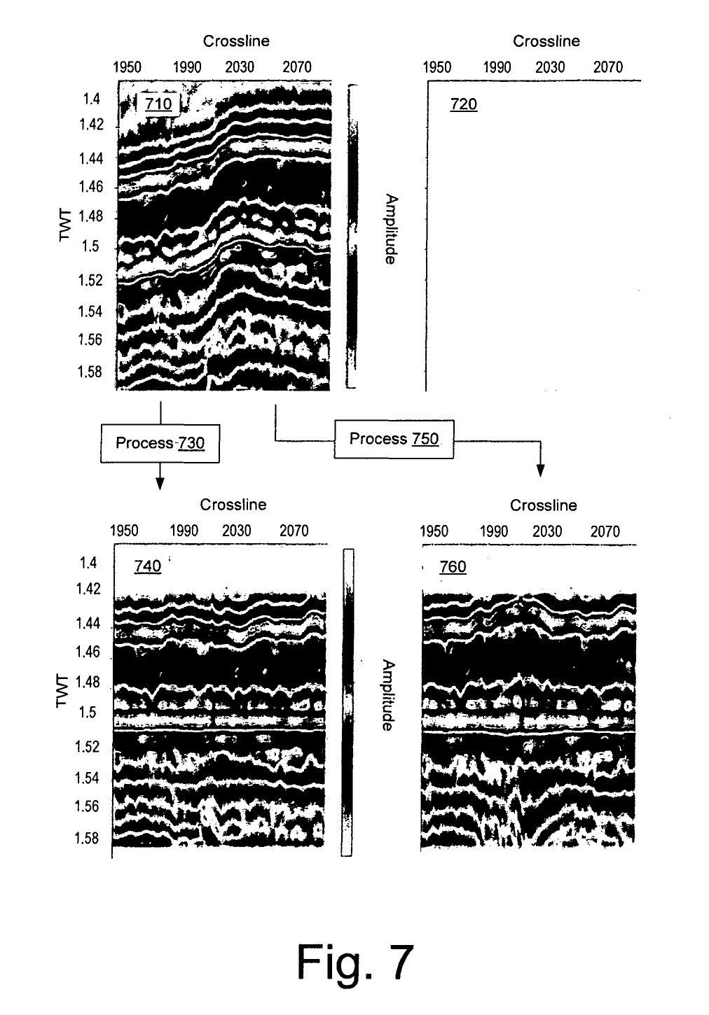

FIG. 7 shows examples of images of data 710, 720, 740 and 760 as being associated with processes 730 and 750. The image of data 710 corresponds to an input section with surface interpretation to identify a surface, which is shown in the image of data 720. In the example of FIG. 7, the process 730 is a flattening process that is applied to the input section where the output is shown in the image of data 740; while the process 750 is a trace extraction process that is applied to the input section where the output is shown in the image of data 760.

As shown in the example of FIG. 7, the process 750 that outputs the image of data 760 provides for a better understanding of the interpreted surface shown in the images of data 710 and 720 when compared to the process 730 that outputs the image of data 740. In particular, the image of data 760 provides for visualization of the tracelets extracted along the surface, for example, to understand better impact of dips and a velocity field going into a ray-tracing algorithm (e.g., optionally as part of the process 750).

Again, as shown in the image of data 740, the seismic traces have been vertically flattened along the interpreted surface; whereas, in the image of data 760, the seismic traces have been “flattened” using the tracelets extracted along the surface normal (e.g., the normal calculated from the dip fields and a velocity field). As shown, extracted tracelets may be provided as input to a RMS operator process along an interpreted surface. In the image of data 760, also note that apparent thicknesses of the layers has changed because the two-way time axis now is indicative of stratigraphic thickness rather than vertical thickness. Such an approach can also alter frequency content in a manner that, in theory, may be closer to the frequency content of the seismic input to the migration, as the process 750 may include correction for skewing of the spectrum received from tracelets extracted vertically.

As an example, if an input seismic is depth-migrated instead of time-migrated, then a vertical unit may be depth rather than time. In such an example, a process may forego an implicit time-to-depth mapping (e.g., a process may proceed without a velocity field as input). As an example, for a process that includes spectral decomposition along the surface normal, an output unit may be given in terms of wavenumber (e.g., number of oscillations per unit length) rather than frequency (e.g., number of oscillations per second).

As an example, a process may be implemented for processing a number of samples where the individual samples are treated as being equally spaced in each direction (e.g., whether 2D or 3D). In such an example, processing may occur in an indexed space (e.g., i, j or i, j, k). As an example, for an indexed space, a common unit distance may exist between neighboring samples. Such a space may exist for an image processing algorithm, for example, that operates directly on pixels/voxels and may ignore details about content of the image (e.g., pixels or voxels). An indexed space may be implemented, for example, where velocity field in the subsurface is unknown, for lateral sampling density, etc.

As an example, subsurface layers, subsurface structures, etc., may be “flatter” than what is inferred by visually presented images of seismic lines rendered to a display (e.g., consider a desktop display). For example, an optical illusion may be due to the fact that seismic lines are often laterally much longer than they are deep. However, when the seismic lines are plotted on a screen (e.g., rendered to a display), the lateral extent may be squeezed (e.g., compressed) to fit as much content as possible of the seismic lines onto the screen. Also, vertical resolution may exceed lateral resolution. As an example, subsurface sampling may be performed using a resolution corresponding to approximately 5 meter per sample (e.g., depending on the velocity in the underground); whereas lateral resolution may exceed approximately 10 meters (e.g., approximately 25 meter or more in a crossline direction). Lack of consistent sampling in 3 dimensions may be underappreciated; hence, as an example, a method may include presenting trajectories of estimated ray-paths used to construct tracelets going into a 1D attribute calculation.

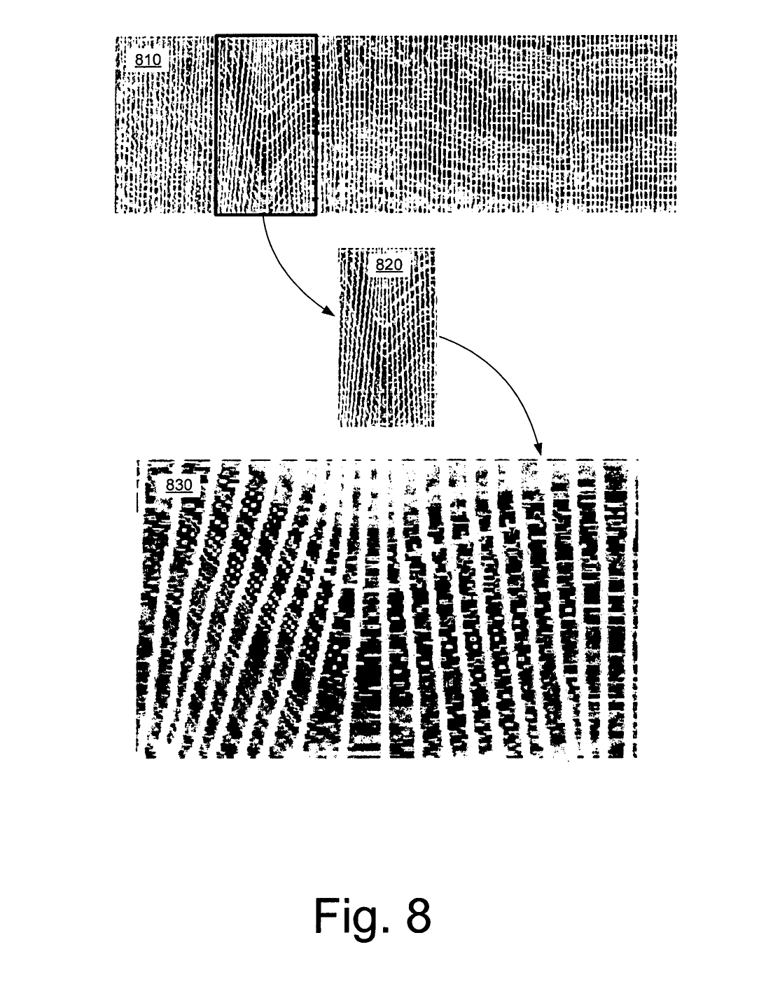

FIG. 8 shows examples of images of data 810, 820 and 830 that include examples of estimates of ray-paths used for constructing tracelets (e.g., according to a process such as the process 460 of the method 400 of FIG. 4).

The image of data 810 shows surface normal vectors plotted on top of a corresponding seismic section. In the image of data 810, calculated normal vectors do not readily appear as being normal to the surfaces, however, this may be explained and demonstrated to be an optical illusion, for example, due to lateral compression.

The image of data 820 is a portion of the data taken from the image of data 810, for which the image of data 830 is an enlargement that shows estimated paths in yellow. The image of data 830 is a laterally cropped portion of the image of data 810, stretched out approximately to its original uncompressed aspect ratio such that normal vectors are rendered “correctly”, for example, together with the layering, to demonstrate that the paths appear visually as being normal to the surfaces.

In the example of FIG. 8, the traces (e.g., “tracelets”) are shown as being separated from one another.

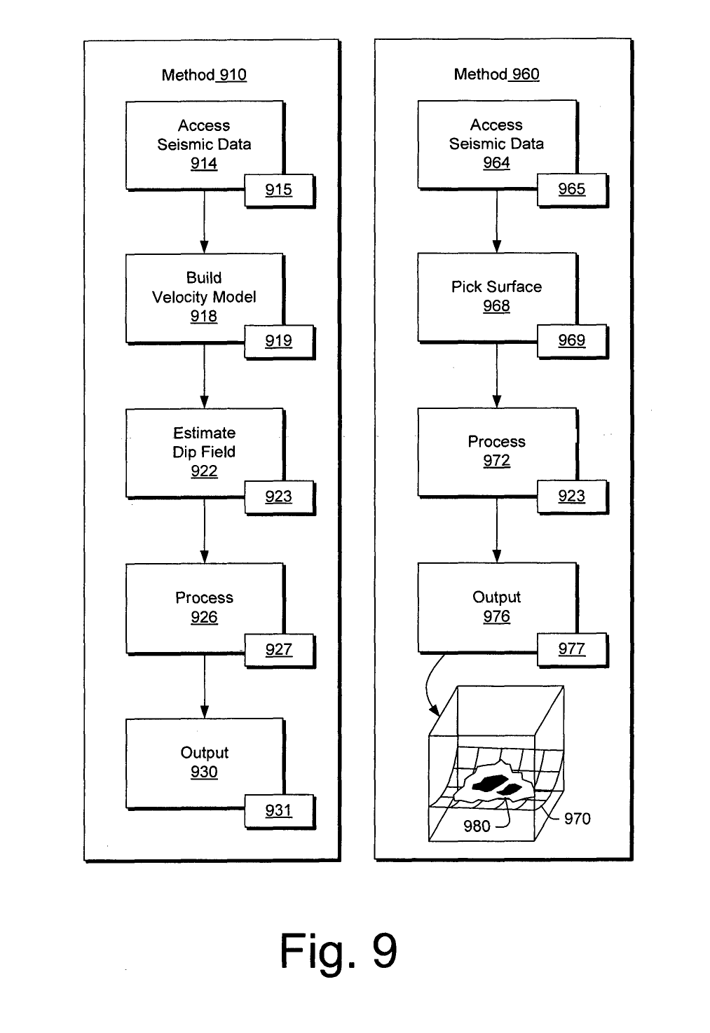

FIG. 9 shows examples of methods 910 and 960. As shown, the method 910 includes an access block 914 for accessing seismic data, a build block 918 for building a velocity model, an estimate block 922 for estimating a dip field, a process block 926 for processing the seismic data using the velocity model and the dip field, and an output block 930 for outputting processed data (e.g., as an attribute surface, attribute volume, etc.). For example, the process block 926 may use the velocity model and the dip field to process the seismic data to generate values for traces organized with respect to appropriate dimensions (e.g., 2D, 3D, etc.). In such an example, the values may be output as processed data, which may be suitable for rendering to a display, further processing, etc. As an example, further processing may include frequency processing, for example, to determine a dominant frequency, a frequency band, etc., for a tracelet (e.g., or “curvelet”) at or proximate to a reflector (e.g., a layer, a geobody, etc.).

As shown in FIG. 9, the method 960 includes an access block 964 for accessing seismic data, a pick block 968 for picking a surface based at least in part on the seismic data, a process block 972 for processing the seismic data using the picked surface and an output block 976 for outputting processed data (e.g., as an attribute surface, attribute volume, etc.). For example, the process block 972 may use the picked surface to process the seismic data to generate values for traces organized with respect to appropriate dimensions (e.g., 2D, 3D, etc.). In such an example, the values may be output as processed data, which may be suitable for rendering to a display, further processing, etc. As an example, further processing may include frequency processing, for example, to determine a dominant frequency, a frequency band, etc., for a tracelet (e.g., or “curvelet”) at or proximate to the picked surface, which may be a reflector (e.g., a layer, a geobody, etc.).

As an example, a picked surface may be associated with a particular lithology, structure, etc. For example, a picked surface may be a sand surface (e.g., top of sand) where a frequency analysis at that surface may provide information germane to determining whether or not hydrocarbons exist in sand associated with that surface. In such an example, a determination may output a probability for the existence of hydrocarbons at a picked surface. As shown in FIG. 9, the output block 976 may output-information sufficient to generate a mapping 980 on a picked surface 970 that indicates probability of hydrocarbons (e.g., based on a frequency analysis).

As an example, a method may be part of a workflow, for example, implemented using a system that includes one or more features of the system 100 of FIG. 1. For example, a process such as that of the process block 460 of FIG. 4 may be implemented to provide a trace attribute (e.g., 2D, 3D, etc.). Such an attribute may include information as to 1D traces that are orthogonal to a surface (e.g., a reflector). Such a trace attribute may be calculated in a manner that aims to preserve one or more characteristics of seismic data that, in turn, allow for frequency processing. For example, seismic data may exist for the geologic environment 150 where the seismic data include wavelets associated with an upper surface of the reservoir 151. Processing of the seismic data may produce a trace attribute for that upper surface that, in turn, allows for frequency processing. In turn, such frequency processing may provide insight as to the existence of hydrocarbons in the reservoir 151 (e.g., consider a sandstone reservoir). As an example, a process may output a map of one or more regions with respect to probability of hydrocarbons being present in the one or more regions.

As an example, a trace attribute may be used in a process that can output RMS values, mean amplitude values, maximum amplitude values, frequency bands, filtered frequencies, sweetness, deconvolution, wavelet estimation, inversion to impedance, energy of wavelet, reflection strength, phase, etc.

The method 910 is shown in FIG. 9 in association with various computer-readable media (CRM) blocks 915, 919, 923, 927 and 931 and the method 960 is shown in FIG. 9 in association with various CRM blocks 965, 969, 973 and 977. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 910, the method 960 or the methods 910 and 960. As an example, a computer-readable medium (CRM) may be a computer-readable storage medium (e.g., a non-transitory medium).

As an example, a computing device or system may include display memory, optionally associated with a GPU, for purposes of rendering data to a display or displays. As an example, a GPU may provide one or more algorithms, for example, to access data, to process data, etc.

As an example, a method can include providing seismic data for a subsurface region that includes a reflector; processing at least a portion of the seismic data to generate at least one path that extends orthogonally to the reflector; and outputting output data representing the at least one path. In such an example, the processing may include ray-tracing. As an example, a subsurface region can include at least one additional reflector, for example, where at least one path extends orthogonally through the at least one additional reflector.

As an example, a method can include transforming a dimension associated with the seismic data from a time domain to a distance domain or from a distance domain to a time domain. For example, a transformation process may include a velocity model.

As an example, a method can include providing one or more dip parameters for a reflector. For example, one or more dip parameters may include an inline dip, a crossline dip or an inline dip and a crossline dip.

As an example, a method may include outputting output data as a trace attribute. As an example, a method may include rendering a trace attribute to a display. As an example, such rendering may include rendering the trace attribute as a path and rendering a reflector as a layer where a path extends orthogonally to the layer.

As an example, processing can include applying interpolation to selected seismic data values to estimate an interpolated seismic data value for the path. In such an example, interpolation may include sinc interpolation (e.g., using a sinc function). As an example, seismic data may include pre-processed seismic data (e.g., a seismic attribute).

As an example, a system may include one or more processors for processing information; memory operatively coupled to the one or more processors; and modules that include instructions stored in the memory and executable by at least one of the one or more processors, where the modules include: a provision module to provide seismic data for a subsurface region that includes a reflector; a process module to process at least a portion of the seismic data to generate at least one path that extends orthogonally to the reflector; and an output module to output data representing the at least one path. In such an example, the system may include a locate module to locate values and an interpolation module to interpolate one or more additional values based at least in part on located values. As an example, a system may include a frequency analysis module to analyze values along at least one generated path, the values being based at least in part on a portion of accessed seismic data.

As an example, an output module may provide for output of output data that represents at least one path via information that specifies locations, for example, where the locations can include locations for seismic data, locations in a subsurface region, etc. In such an example, a trace (e.g., a tracelet) may be reconstructed based on such information (e.g., provided as a table, a function, etc.), optionally as associated with a seismic data cube, an attribute cube, a model, etc.

As an example, one or more computer-readable storage media can include computer-executable instructions to instruct a computing system to: access seismic data for a subsurface region that includes a reflector; process at least a portion of the seismic data to generate at least one path that extends orthogonally to the reflector; and output data representing the at least one path. In such an example, computer-executable instructions may be included to instruct a computing system to pick a surface in the subsurface region where the surface corresponds to the reflector. As an example, computer-executable instructions may be included to instruct a computing system to analyze values along at least one generated path, the values being based at least in part on a portion of accessed seismic data.

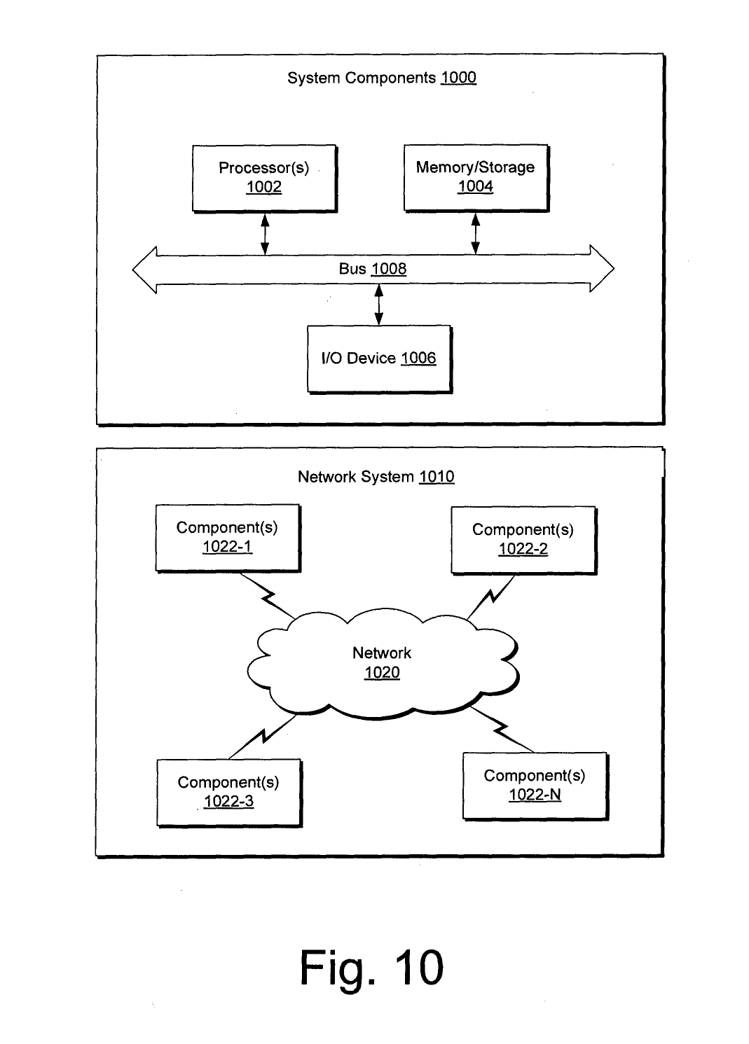

FIG. 10 shows components of an example of a computing system 1000 and an example of a networked system 1010. The system 1000 includes one or more processors 1002, memory and/or storage components 1004, one or more input and/or output devices 1006 and a bus 1008. In an example embodiment, instructions may be stored in one or more computer-readable media (e.g., memory/storage components 1004). Such instructions may be read by one or more processors (e.g., the processor(s) 1002) via a communication bus (e.g., the bus 1008), which may be wired or wireless. The one or more processors may execute such instructions to implement (wholly or in part) one or more attributes (e.g., as part of a method). A user may view output from and interact with a process via an I/O device (e.g., the device 1006). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1010. The network system 1010 includes components 1022-1, 1022 -2, 1022-3, . . . 1022-N. For example, the components 1022-1 may include the processor(s) 1002 while the component(s) 1022-3 may include memory accessible by the processor(s) 1002. Further, the component(s) 1002-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method (400) comprising:
providing seismic data for a subsurface region that comprises a reflector (410);
processing at least a portion of the seismic data to generate at least one path that extends orthogonally to the reflector (460); and
outputting output data representing the at least one path (480).

2. The method of claim 1 wherein the processing comprises ray-tracing.

3. The method of claim 1 wherein the subsurface region comprises at least one additional reflector.

4. The method of claim 3 wherein the at least one path extends orthogonally through the at least one additional reflector.

5. The method of claim 1 comprising transforming a dimension associated with the seismic data from a time domain to a distance domain or from a distance domain to a time domain.

6. The method of claim 5 wherein the transforming comprises using a velocity model.

7. The method of claim 1 comprising providing one or more dip parameters for the reflector.

8. The method of claim 7 wherein the one or more dip parameters comprise an inline dip, a crossline dip or an inline dip and a crossline dip.

9. The method of claim 1 wherein the outputting comprises outputting the output data as a trace attribute.

10. The method of claim 9 comprising rendering the trace attribute to a display.

11. The method of claim 10 wherein the rendering comprises rendering the trace attribute as a path and rendering the reflector as a layer wherein the path extends orthogonally to the layer.

12. The method of claim 1 wherein the processing comprises applying interpolation to selected seismic data values to estimate an interpolated seismic data value for the path.

13. The method of claim 12 wherein the interpolation comprises sinc interpolation.

14. The method of claim 1 wherein the seismic data comprises pre-processed seismic data.

15. A system comprising:
one or more processors for processing information;
memory operatively coupled to the one or more processors; and
modules that comprise instructions stored in the memory and executable by at least one of the one or more processors, wherein the modules comprise:
a provision module to provide seismic data for a subsurface region that comprises a reflector (411);
a process module to process at least a portion of the seismic data to generate at least one path that extends orthogonally to the reflector (461); and
an output module to output data representing the at least one path (481).

16. The system of claim 15 comprising a locate module to locate values and an interpolation module to interpolate one or more additional values based at least in part on located values.

17. The system of claim 15 wherein the output module outputs output data representing the at least one path via information that specifies locations wherein the locations comprise locations for seismic data or locations in the subsurface region.

18. One or more computer-readable storage media comprising computer-executable instructions to instruct a computing system to:
access seismic data for a subsurface region that comprises a reflector (915);
process at least a portion of the seismic data to generate at least one path that extends orthogonally to the reflector (927); and
output data representing the at least one path (931).

19. The one or more computer-readable storage media of claim 18 comprising computer-executable instructions to instruct a computing system to pick a surface in the subsurface region wherein the surface corresponds to the reflector.

20. The one or more computer-readable storage media of claim 18 comprising computer-executable instructions to instruct a computing system to analyze values along the at least one generated path, the values being based at least in part on the portion of the seismic data.
